(19) United States
(12) Patent Application Publication
(10) Pub. No.: US 2025/0250425 A1
(43) Pub. Date: Aug. 7, 2025

(54) RUBBER COMPOSITION AND PNEUMATIC TIRE

(71) Applicant: Toyo Tire Corporation, Itami-shi (JP)

(72) Inventor: Yuuki IKEUCHI, Itami-shi (JP)

(73) Assignee: Toyo Tire Corporation, Itami-shi (JP)

(21) Appl. No.: 19/005,095

(22) Filed: Dec. 30, 2024

(30) Foreign Application Priority Data
Feb. 1, 2024 (JP) 2024-013830

(51) Int. Cl. C08L 9/06; B60C 1/00; C08K 3/04; C08L 7/00

(52) U.S. Cl. CPC C08L 9/06; B60C 1/00; C08K 3/04; C08L 7/00; C08K 2201/006; C08L 2205/025; C08L 2207/322; C08L 2312/02

(57) ABSTRACT

A rubber composition containing a diene-based rubber, carbon black, and vegetable oil, wherein the carbon black has a ratio (N₂SA/IA) between nitrogen adsorption specific surface area (N₂SA) m²/g and iodine adsorption (IA) mg/g of 0.9 m²/mg or less, and the vegetable oil is a glycerin fatty acid triester. It is preferred that the carbon black is recovered carbon black. It is preferred that the vegetable oil has an iodine value of 90 or less.

### BACKGROUND OF THE INVENTION

### Field of the Invention

The present invention relates to a rubber composition and a pneumatic tire.

### Description of the Related Art

Due to a recent request for resource saving, pneumatic tires are required to be fuel-efficient and are therefore required to have improved low heat build-up contributing to fuel-efficiency. Further, from the viewpoint of improving durability, pneumatic tires are also required to achieve reinforcement.

Meanwhile, companies have recently been required to address SDGs, which means Sustainable Development Goals, irrespective of the intended uses of pneumatic tires and the like. SDGs consists of 17 goals, and SDGs12-5 (By 2030, substantially reduce waste generation through prevention, reduction, and reuse) is one of them.

Patent Document 1 mentioned below discloses a rubber composition containing at least a rubber component, carbon black, and sodium (2Z)-4-[(4-aminophenyl) amino]-4-oxo-2-butenoate, wherein the carbon black contains at least carbon black having a surface activity ((N₂SA)/(IA)) of 1.0 or more.

Patent Document 2 mentioned below discloses carbon black used for rubber compositions, wherein (N₂SA)/(IA) of the carbon black is 1.10 to 1.50.

Patent Document 3 mentioned below discloses a rubber composition for belt coating rubber, the rubber composition containing a rubber component, carbon black whose (N₂SA)/(IA) is 1.2 or less, and a resin component containing a phenol resin and a methylene donor.

PRIOR ART DOCUMENT

### Patent Documents

Patent Document 1: JP-A-2020-23646

Patent Document 2: JP-B2-7087219

Patent Document 3: JP-B2-7280003

### SUMMARY OF THE INVENTION

When carbon black having low surface activity is used as a reinforcing agent, the effect of improving the rubber properties of a vulcanized rubber to be finally obtained tends to be poor. For this reason, it is presumed that, in consideration of such a tendency, the techniques disclosed in Patent Documents 1 to 3 mentioned above use carbon black having high surface activity. However, the techniques disclosed in Patent Documents 1 and 2 mentioned above may deteriorate low heat build-up of a vulcanized rubber to be finally obtained, thereby deteriorating fuel-efficiency of a resultant pneumatic tire. Further, in the case of the technique disclosed in Patent Document 3 mentioned above, carbon black whose (N₂SA)/(IA) is 0.95 to 1.33 is described as a specific example of carbon black contained in the rubber composition. Therefore, this technique may also deteriorate low heat-build up of a vulcanized rubber to be finally obtained, thereby deteriorating fuel-efficiency of a resultant pneumatic tire.

In light of such circumstances, it is an object of the present invention to provide a rubber composition for use as a raw material of a vulcanized rubber for tires achieving a good balance between low heat build-up and reinforcement, and a pneumatic tire including a vulcanized rubber of the rubber composition.

The above object can be achieved by the following configurations. Specifically, the present invention relates to a rubber composition (1) containing a diene-based rubber, carbon black, and vegetable oil, wherein the carbon black has a ratio (N₂SA/IA) between nitrogen adsorption specific surface area (N₂SA) m²/g and iodine adsorption (IA) mg/g of 0.9 m²/mg or less, and the vegetable oil is a glycerin fatty acid triester.

The rubber composition (1) is preferably a rubber composition (2) in which the carbon black is recovered carbon black.

The rubber composition (1) or (2) is preferably a rubber composition (3) in which the vegetable oil has an iodine value of 90 or less.

The present invention also relates to a pneumatic tire (4) including at least a vulcanized rubber of any one of the rubber compositions (1) to (3).

As for carbon black, the ratio (N₂SA/IA) between nitrogen adsorption specific surface area (N₂SA) m²/g and iodine adsorption (IA) mg/g represents the surface activity of carbon black, and a higher ratio means higher surface activity and a lower ratio means lower surface activity. Carbon black with low surface activity has a low rubber-reinforcing property and deteriorates filler dispersibility and processability, and therefore the effect of improving the rubber properties of a vulcanized rubber to be finally obtained tends to be poor. In the present invention, carbon black whose ratio (N₂SA)/(IA) between nitrogen adsorption specific surface area (N₂SA) m²/g and iodine adsorption (IA) mg/g is 0.9 m²/mg or less is used. It is predicted that the use of such carbon black with low surface activity will deteriorate the rubber properties of a vulcanized rubber to be finally obtained. However, the rubber composition according to the present invention contains, in addition to carbon black whose ratio (N₂SA)/(IA) between nitrogen adsorption specific surface area (N₂SA) m²/g and iodine adsorption (IA) mg/g is 0.9 m²/mg or less, a glycerin fatty acid triester as vegetable oil. As a result, contrary to expectation, the vulcanized rubber finally obtained achieves a good valance between improved low heat build-up and improved reinforcement. The reason why such an effect is obtained is not clear, but one of possible reasons is as follows: a glycerin fatty acid triester has an appropriate amount of double bonds as compared to mineral oil, and therefore when carbon black with low surface activity and a glycerin fatty acid triester having an appropriate amount of double bonds are kneaded in a diene-based rubber, a reduction in rubber viscosity during kneading is prevented and dispersibility of the carbon black can be improved even when the surface activity of the carbon black is low.

When the rubber composition according to the present invention uses recovered carbon black as the carbon black, the value of N₂SA/IA tends to be low due to a high ash content of the recovered carbon black, and in addition, rubber viscosity is likely to increase during kneading due to ash. However, when the rubber composition contains recovered carbon black whose N₂SA/IA is 0.9 m²/mg or less and a glycerin fatty acid triester, rubber viscosity during kneading can be adjusted to fall within an appropriate range, which makes it possible for a vulcanized rubber to be finally obtained to, even when recovered carbon black is used, achieve a good balance between improved low heat build-up and improved reinforcement. In addition, the use of recovered carbon black makes it possible to significantly reduce waste generation through prevention, reduction, and reuse in response to the SDGs.

When the rubber composition according to the present invention contains, as vegetable oil, a glycerin fatty acid triester having an iodine value of 90 or less, the occurrence of scorch can be prevented during vulcanization of the diene-based rubber, and in addition, the glycerin fatty acid triester exhibits the effect as a plasticizer and contributes to improved dispersibility of the carbon black. This compensates for low interaction between the carbon black with low surface activity and the diene-based rubber, which makes it possible for a vulcanized rubber to be finally obtained to achieve a good balance between improved low heat build-up and improved reinforcement.

A vulcanized rubber of the rubber composition according to the present invention achieves a good balance between improved low heat build-up and improved reinforcement. Therefore, a vulcanized rubber of the rubber composition according to the present invention is particularly useful for pneumatic tire treads.

### DETAILED DESCRIPTION OF THE PREFERRED EMBODIMENTS

A rubber composition according to the present invention contains a diene-based rubber, carbon black, and vegetable oil.

Examples of the diene-based rubber include, but are not limited to, natural rubber (NR), isoprene rubber (IR), butadiene rubber (BR), styrene-butadiene rubber (SBR), acrylonitrile-butadiene rubber (NBR), chloroprene rubber (CR), styrene-isoprene copolymer rubber, a butadiene-isoprene copolymer rubber, and styrene-isoprene-butadiene copolymer rubber. These diene-based rubbers may be used singly or in combination of two or more of them.

The rubber composition according to the present invention contains carbon black whose ratio (N₂SA/IA) between nitrogen adsorption specific surface area (N₂SA) m²/g and iodine adsorption (IA) mg/g is 0.9 m²/mg or less. The lower limit of N₂SA/IA of the carbon black to be used is preferably 0.50 m²/mg, more preferably 0.70 m²/mg. The upper limit of N₂SA/IA of the carbon black to be used is preferably 0.85 m²/mg. The nitrogen adsorption specific surface area (N₂SA) and the iodine adsorption (IA) can be measured on the basis of JIS K6217-2 and JIS K6217-1, respectively. In the present invention, from the viewpoint of considering environmental aspects in response to SDGs, recovered carbon black whose N₂SA/IA is 0.9 m²/mg or less is preferably used. In the present invention, the lower limit of content of the carbon black whose ratio (N₂SA/IA) between nitrogen adsorption specific surface area (N₂SA) m²/g and iodine adsorption (IA) mg/g is 0.9 m²/mg or less is preferably 3 parts by mass, more preferably 5 parts by mass when the entire amount of a rubber component is taken as 100 parts by mass. On the other hand, the upper limit of the content is preferably 100 parts by mass, more preferably 90 parts by mass when the entire amount of a rubber component is taken as 100 parts by mass. It should be noted that in the present invention, carbon black whose N₂SA/IA exceeds 0.9 m²/mg can also be used. However, in order to sufficiently exert the effect of the present invention, the amount of carbon black to be used, whose N₂SA/IA exceeds 0.9 m²/mg, is preferably 75 mass % or less, more preferably 70 mass % or less of the total amount of carbon blacks to be used.

The rubber composition according to the present invention is characterized in that, in addition to the carbon black whose ratio (N₂SA/IA) between nitrogen adsorption specific surface area (N₂SA) m²/g and iodine adsorption (IA) mg/g is 0.9 m²/mg or less, a glycerin fatty acid triester is contained as vegetable oil. When the rubber composition according to the present invention contains a glycerin fatty acid triester, especially a glycerin fatty acid triester having an iodine value of 90 or less, the occurrence of scorch can be prevented during vulcanization of the diene-based rubber because such a glycerin fatty acid triester has an appropriate amount of double bonds, and in addition, the glycerin fatty acid triester exhibits the effect as a plasticizer and contributes to improved dispersibility of the carbon black, which makes it possible for a vulcanized rubber to be finally obtained to achieve a good balance between improved low heat build-up and improved reinforcement. If the iodine value of the glycerin fatty acid triester is excessively low, the melting point of the glycerin fatty acid triester significantly increases, and therefore handleability tends to deteriorate. For this reason, the lower limit of the iodine value is preferably 60, more preferably 65. On the other hand, if the iodine value of the glycerin fatty acid triester is excessively high, the amount of double bonds increases, which may make it difficult to prevent the occurrence of scorch during vulcanization of the diene-based rubber. From the viewpoint of achieving a good balance between improved low heat build-up and improved reinforcement while improving the processability of the rubber composition, the glycerin fatty acid triester used in the present invention is particularly preferably sunflower oil or palm oil. The lower limit of content of the vegetable oil (glycerin fatty acid triester) used in the present invention is preferably 3 parts by mass, more preferably 5 parts by mass when the entire amount of a rubber component is taken as 100 parts by mass. On the other hand, the upper limit of content of the vegetable oil (glycerin fatty acid triester) used in the present invention is preferably 30 parts by mass, more preferably 25 parts by mass when the entire amount of a rubber component is taken as 100 parts by mass.

The rubber composition according to the present invention may contain, in addition to the diene-based rubber, the carbon black, and the vegetable oil, silica, a silane coupling agent, a vulcanizing agent, a vulcanization accelerator, an antiaging agent, stearic acid, wax, a softener such as oil, processing aid, and others.

Examples of the silica to be used include silicas usually used for rubber reinforcement, such as wet silica, dry silica, sol-gel silica, and surface-treated silica. Among these, wet silica is preferred. However, from the viewpoint of maintaining the effect of improving the dispersibility of carbon black at a higher level, the rubber composition according to the present invention preferably contains no silica, and even when silica is contained, the content of the silica is preferably 10 parts by mass or less, more preferably 5 parts by mass or less when the entire amount of a rubber component is taken as 100 parts by mass.

When silica is contained as a filler, a silane coupling agent is also preferably contained together. The silane coupling agent is not limited as long as sulfur is contained in the molecule thereof, and various silane coupling agents to be added to rubber compositions together with silica may be used. Examples of such silane coupling agents include: sulfidesilanes such as bis(3-triethoxysilylpropyl)tetrasulfide (e.g., “Si69” manufactured by Evonik Japan Co., Ltd.), bis(3-triethoxysilylpropyl)disulfide (e.g., “Si75” manufactured by Evonik Japan Co., Ltd.), bis(2-triethoxysilylethyl)tetrasulfide, bis(4-triethoxysilylbutyl)disulfide, bis(3-trimethoxysilylpropyl) tetrasulfide, and bis(2-trimethoxysilylethyl)disulfide; mercaptosilanes such as γ-mercaptopropyltrimethoxysilane, γ-mercaptopropyltriethoxysilane, mercaptopropylmethyldimethoxysilane, mercaptopropyldimethylmethoxysilane, and mercaptoethyltriethoxysilane; and protected mercaptosilanes such as 3-octanoylthio-1-propyltriethoxysilane and 3-propionylthiopropyltrimethoxysilane.

As the vulcanizing agent, sulfur can suitably be used. The sulfur may be ordinary sulfur for rubber, and sulfur such as powdered sulfur, precipitated sulfur, insoluble sulfur, or highly dispersible sulfur can be used. The content of the vulcanizing agent in the rubber composition according to the present invention is preferably 0.5 to 3.5 parts by mass when the entire amount of a rubber component is taken as 100 parts by mass.

Examples of the vulcanization accelerator include vulcanization accelerators usually used for rubber vulcanization, such as a sulfenamide-based vulcanization accelerator, a thiuram-based vulcanization accelerator, a thiazole-based vulcanization accelerator, a thiourea-based vulcanization accelerator, a guanidine-based vulcanization accelerator, and a dithiocarbamic acid salt-based vulcanization accelerator, and these may be used singly or in an appropriate combination of two or more of them.

Examples of the antiaging agent include antiaging agents usually used for rubber, such as an aromatic amine-based antiaging agent, an amine-ketone-based antiaging agent, a monophenol-based antiaging agent, a bisphenol-based antiaging agent, a polyphenol-based antiaging agent, a dithiocarbamic acid salt-based antiaging agent, and a thiourea-based antiaging agent, and these may be used singly or in an appropriate combination of two or more of them.

The rubber composition according to the present invention is obtained by kneading, in addition to the diene-based rubber, the carbon black, and the vegetable oil, silica, a silane coupling agent, a vulcanizing agent, a vulcanization accelerator, zinc oxide, an antiaging agent, stearic acid, wax, a softener such as oil, a processing aid, and others with the use of a kneading machine usually used in the rubber industry, such as a Banbury mixer, a kneader, or a roll.

A method for blending the above components is not limited, and any one of the following methods may be used: a method in which components to be blended other than vulcanization-type compounding agents such as a vulcanizing agent and a vulcanization accelerator are previously kneaded to prepare a master batch, the remaining components are added to the master batch, and the resultant is further kneaded, a method in which components are added in any order and kneaded, and a method in which all the components are added at the same time and kneaded.

A vulcanized rubber of the rubber composition according to the present invention achieves a good balance between improved low heat build-up and improved reinforcement. Therefore, a vulcanized rubber of the rubber composition according to the present invention is useful for all pneumatic tire members, especially pneumatic tire treads.

### EXAMPLES

Hereinbelow, the present invention will more specifically be described with reference to examples.

### Preparation of Rubber Compositions for Tires

A rubber composition for tires of each of Examples 1 to 7 and Comparative Examples 1 to 6 was prepared by blending compounding agents with 100 parts by mass of a rubber component in accordance with a formulation shown in any one of Tables 1 to 5 and kneading the resultant using an ordinary Banbury mixer. The compounding agents shown in Tables 1 to 5 are as follows.

### Rubber Component

Natural rubber (NR): RSS #3
Butadiene rubber (BR): trade name “BR150B” (manufactured by UBE Elastomer Co., Ltd.)
Styrene-butadiene rubber (SBR (ESBR (emulsion-polymerized SBR))): trade name “SBR1502” (manufactured by ENEOS Materials Corporation)

### Carbon Black

CB1 (HAF): trade name “Seast 3” (manufactured by TOKAI CARBON CO., LTD.), (N₂SA) 75 m²/g, (IA) 80 mg/g, (N₂SA/IA) 0.94 m²/mg
CB2: trade name “SC31” (manufactured by CSRC), (N₂SA) 74 m²/g, (IA) 87 mg/g, (N₂SA/IA) 0.85 m²/mg
CB3: trade name “SC51” (manufactured by CSRC), (N₂SA) 39 m²/g, (IA) 46 mg/g, (N₂SA/IA) 0.85 m²/mg
CB4: trade name “SC61” (manufactured by CSRC), (N₂SA) 37 m²/g, (IA) 42 mg/g, (N₂SA/IA) 0.88 m²/mg
CB5 (recovered carbon black): trade name “PB-365” (manufactured by Enrestec Inc.), (N₂SA) 73 m²/g, (IA) 92 mg/g, (N₂SA/IA) 0.79 m²/mg

### Vegetable Oil

Vegetable oil 1 (sunflower oil): (manufactured by The Nisshin OilliO Group, Ltd.), iodine value: 84, oleic acid: 82 wt %
Vegetable oil 2 ((PL65 (palm olein)): (manufactured by The Nisshin OilliO Group, Ltd.), iodine value: 65, oleic acid: 48 wt %

### Other Components

Mineral oil (naphthenic oil): trade name “Process NC140” (manufactured by JOMO)
Silica: trade name “Nipsil AQ” (manufactured by Tosoh Corporation)
Silane coupling agent: trade name “Si69” (manufactured by Evonik Japan Co., Ltd.)
Zinc oxide: trade name “Zinc White Grade 1” manufactured by MITSUI MINING & SMELTING CO., LTD.
Stearic acid: trade name “LUNAC S-20” (manufactured by Kao Corporation)
Wax: trade name “OZOACE 0355” (manufactured by Nippon Seiro Co., Ltd.)
Antiaging agent 1: trade name “NOCRAC 6C” (manufactured by OUCHI SHINKO CHEMICAL INDUSTRIAL CO., LTD.)
Antiaging agent 2: trade name “ANTAGE RD” (manufactured by Kawaguchi Chemical Industry Co., Ltd.)
Hydrocarbon resin: trade name “Petrotack 90” (manufactured by Tosoh Corporation)
Vulcanization accelerator 1: trade name “SOXINOL CZ” (manufactured by SUMITOMO CHEMICAL COMPANY, LIMITED)
Vulcanization accelerator 2: trade name “NOCCELER NS-P” (manufactured by OUCHI SHINKO CHEMICAL INDUSTRIAL CO., LTD.)
Sulfur: trade name “Powder Sulfur” (manufactured by Tsurumi Chemical Industry Co., ltd.)

Unvulcanized samples of the rubber compositions of Examples 1 to 7 and Comparative Examples 1 to 6 obtained above were prepared, and then viscosity (processability) of the unvulcanized rubber compositions and low heat build-up (rolling resistance) and reinforcement of vulcanized rubbers were evaluated according to the following criteria.

### Viscosity (Processability) of Unvulcanized Rubber Compositions

In accordance with JIS K6300, the unvulcanized rubber was preheated at 100° C. for 1 minute and then a torque value after 4 minutes was measured in Mooney unit using a rotor-less Mooney viscometer manufactured by Toyo Seiki Seisaku-sho, Ltd. In the case of Example 1 and Comparative Example 1, viscosity was expressed as an index number determined when the viscosity of Comparative Example 2 was taken as 100, in the case of Examples 2 and 3, the viscosity was expressed as an index number determined when the viscosity of Comparative Example 3 was taken as 100, in the case of Example 4, the viscosity was expressed as an index number determined when the viscosity of Comparative Example 4 was taken as 100, in the case of Examples 5 and 6, the viscosity was expressed as an index number determined when the viscosity of Comparative Example 5 was taken as 100, and in the case of Example 7, the viscosity was expressed as an index number determined when the viscosity of Comparative Example 6 was taken as 100. A smaller index number indicates that the viscosity of the unvulcanized rubber is lower and processability is more excellent.

### Reinforcement of Vulcanized Rubber (Tensile Product)

A tensile test was performed in accordance with JIS K6251 using a JIS No.3 dumbbell test piece to determine a tensile product (tensile strength (MPa)×elongation at break (%)). In the case of Example 1 and Comparative Example 1, the tensile product was expressed as an index number determined when the tensile product of Comparative Example 2 was taken as 100, in the case of Examples 2 and 3, the tensile product was expressed as an index number determined when the tensile product of Comparative Example 3 was taken as 100, in the case of Example 4, the tensile product was expressed as an index number determined when the tensile product of Comparative Example 4 was taken as 100, in the case of Examples 5 and 6, the tensile product was expressed as an index number determined when the tensile product of Comparative Example 5 was taken as 100, and in the case of Example 7, the tensile product was expressed as an index number determined when the tensile product of Comparative Example 6 was taken as 100. A larger index number indicates that the tensile product of the vulcanized rubber is higher and the carbon black is more excellent in reinforcing effect.

### Low Heat Build-Up (Rolling Resistance) of Vulcanized Rubber

A loss factor tan o was measured at a frequency of 10 Hz, a static strain of 10%, a dynamic strain of 1%, and a temperature of 60° C. using a viscoelasticity tester manufactured by Toyo Seiki Seisaku-sho, Ltd. In the case of Example 1 and Comparative Example 1, low heat build-up was expressed as an index number determined when the loss coefficient of Comparative Example 2 was taken as 100, in the case of Examples 2 and 3, low heat build-up was expressed as an index number determined when the loss coefficient of Comparative Example 3 was taken as 100, in the case of Example 4, low heat build-up was expressed as an index number determined when the loss coefficient of Comparative Example 4 was taken as 100, in the case of Examples 5 and 6, low heat build-up was expressed as an index number determined when the loss coefficient of Comparative Example 5 was taken as 100, and in the case of Example 7, low heat build-up was expressed as an index number determined when the loss coefficient of Comparative Example 6 was taken as 100. A smaller index number indicates that less heat is generated and therefore rolling resistance performance is more excellent.

TABLE 1

| | | |
|---|---|---|
| Comparative | Comparative | |
| Example 1 | Example 2 | Example 1 |

(Formulation)

| | | | |
|---|---|---|---|
| NR | 40 | 40 | 40 |
| BR | 60 | 60 | 60 |
| SBR | | | |
| CB1 | 50 | | |
| CB2 | | 50 | 50 |
| CB3 | | | |
| CB4 | | | |
| CB5 | | | |
| Silica | 10 | 10 | 10 |
| Silane coupling agent | 1 | 1 | 1 |
| Mineral oil (naphthenic oil) | 10 | 10 | |
| Vegetable oil 1 (sunflower oil) | | | 10 |
| Vegetable oil 2 (palm olein) | | | |
| Zinc oxide | 2 | 2 | 2 |
| Stearic acid | 2 | 2 | 2 |
| Wax | 2 | 2 | 2 |
| Antiaging agent 1 | 2 | 2 | 2 |
| Antiaging agent 2 | 2 | 2 | 2 |
| Hydrocarbon resin | 2.5 | 2.5 | 2.5 |
| Vulcanization accelerator 1 | 1 | 1 | 1 |
| Vulcanization accelerator 2 | | | |
| Sulfur | 2 | 2 | 2 |

(Evaluations)

| | | | |
|---|---|---|---|
| Viscosity (Processability) | 99 | 100 | 99 |
| Tensile product (reinforcement) | 110 | 100 | 113 |
| Low heat build-up (rolling | 106 | 100 | 95 |
| resistance) | | | |

As can be seen from the results shown in Table 1, the vulcanized rubber of the rubber composition of Comparative Example 1 containing CB1 whose N₂SA/IA is 0.94 m²/mg and mineral oil (naphthenic oil) has achieved improved reinforcement but has significantly deteriorated in low heat build-up as compared to the vulcanized rubber of the rubber composition of Comparative Example 2 containing CB2 whose N₂SA/IA is 0.85 m²/mg and mineral oil (naphthenic oil). On the other hand, the vulcanized rubber of the rubber composition of Example 1 containing CB2 whose N₂SA/IA is 0.85 m²/mg and vegetable oil 1 (sunflower oil) has achieved improved reinforcement and significantly improved low heat build-up.

TABLE 2

| | | |
|---|---|---|
| Comparative | | |
| Example 3 | Example 2 | Example 3 |

(Formulation)

| | | | |
|---|---|---|---|
| NR | 50 | 50 | 50 |
| BR | 50 | 50 | 50 |
| SBR | | | |
| CB1 | | | |
| CB2 | | | |
| CB3 | 35 | 35 | 35 |
| CB4 | | | |
| CB5 | | | |
| Silica | | | |
| Silane coupling agent | | | |
| Mineral oil (naphthenic oil) | 8 | | |
| Vegetable oil 1 (sunflower oil) | | 8 | |
| Vegetable oil 2 (palm olein) | | | 8 |
| Zinc oxide | 2.5 | 2.5 | 2.5 |
| Stearic acid | 2.5 | 2.5 | 2.5 |
| Wax | 2 | 2 | 2 |
| Antiaging agent 1 | 3 | 3 | 3 |
| Antiaging agent 2 | | | |
| Hydrocarbon resin | 2 | 2 | 2 |
| Vulcanization accelerator 1 | 0.6 | 0.6 | 0.6 |
| Vulcanization accelerator 2 | | | |
| Sulfur | 2.5 | 2.5 | 2.5 |

(Evaluations)

| | | | |
|---|---|---|---|
| Viscosity (Processability) | 100 | 99 | 98 |
| Tensile product (reinforcement) | 100 | 113 | 116 |
| Low heat build-up (rolling | 100 | 95 | 94 |
| resistance) | | | |

As can be seen from the results shown in Table 2, the vulcanized rubber of the rubber composition of Example 2 containing CB3 whose N₂SA/IA is 0.85 m²/mg and vegetable oil 1 (sunflower oil) and the vulcanized rubber of the rubber composition of Example 3 containing CB2 whose N₂SA/IA is 0.85 m²/mg and vegetable oil 2 (palm olein) both have achieved improved reinforcement and significantly improved low heat build-up as compared to the vulcanized rubber of the rubber composition of Comparative Example 3 containing CB3 whose N₂SA/IA is 0.85 m²/mg and mineral oil (naphthenic oil).

TABLE 3

| | |
|---|---|
| Comparative | |
| Example 4 | Example 4 |

(Formulation)

| | | |
|---|---|---|
| NR | 80 | 80 |
| BR | | |
| SBR | 20 | 20 |
| CB1 | | |
| CB2 | | |
| CB3 | 84 | 84 |
| CB4 | | |
| CB5 | | |
| Silica | | |
| Silane coupling agent | | |
| Mineral oil (naphthenic oil) | 7 | |
| Vegetable oil 1 (sunflower oil) | | 7 |
| Vegetable oil 2 (palm olein) | | |
| Zinc oxide | 7 | 7 |
| Stearic acid | 2 | 2 |
| Wax | | |
| Antiaging agent 1 | | |
| Antiaging agent 2 | 1 | 1 |
| Hydrocarbon resin | 20 | 20 |
| Vulcanization accelerator 1 | | |
| Vulcanization accelerator 2 | 1.5 | 1.5 |
| Sulfur | 5 | 5 |

(Evaluations)

| | | |
|---|---|---|
| Viscosity (Processability) | 100 | 96 |
| Tensile product (reinforcement) | 100 | 115 |
| Low heat build-up (rolling | 100 | 96 |
| resistance) | | |

The blend systems shown in Table 3 are different from the blend systems shown in Table 2 in that a different type of diene-based rubber is used and the content of carbon black is increased. As can be seen from the results shown in Table 3, the vulcanized rubber of the rubber composition of Example 4 containing CB3 whose N₂SA/IA is 0.85 m²/mg and vegetable oil 1 (sunflower oil) has achieved improved reinforcement and significantly improved low heat build-up as compared to the vulcanized rubber of the rubber composition of Comparative Example 4 containing CB3 whose N₂SA/IA is 0.85 m²/mg and mineral oil (naphthenic oil).

TABLE 4

| | | |
|---|---|---|
| Comparative | | |
| Example 5 | Example 5 | Example 6 |

(Formulation)

| | | | |
|---|---|---|---|
| NR | 40 | 40 | 40 |
| BR | | | |
| SBR | 60 | 60 | 60 |
| CB1 | 40 | 40 | 40 |
| CB2 | | | |
| CB3 | | | |
| CB4 | 20 | 20 | 20 |
| CB5 | | | |
| Silica | | | |
| Silane coupling agent | | | |
| Mineral oil (naphthenic oil) | 15 | | |
| Vegetable oil 1 (sunflower oil) | | 15 | |
| Vegetable oil 2 (palm olein) | | | 15 |
| Zinc oxide | 3 | 3 | 3 |
| Stearic acid | 2 | 2 | 2 |
| Wax | | | |
| Antiaging agent 1 | | | |
| Antiaging agent 2 | 0.5 | 0.5 | 0.5 |
| Hydrocarbon resin | 3 | 3 | 3 |
| Vulcanization accelerator 1 | 0.8 | 0.8 | 0.8 |
| Vulcanization accelerator 2 | | | |
| Sulfur | 2.5 | 2.5 | 2.5 |

(Evaluations)

| | | | |
|---|---|---|---|
| Viscosity (Processability) | 100 | 85 | 88 |
| Tensile product (reinforcement) | 100 | 126 | 130 |
| Low heat build-up (rolling | 100 | 94 | 94 |
| resistance) | | | |

The blend systems shown in Table 4 are systems using CB1 whose N₂SA/IA is 0.94 m²/mg and CB4 whose N₂SA/IA is 0.88 m²/mg in combination. As can be seen from the results shown in Table 4, the vulcanized rubber of the rubber composition of Example 5 containing vegetable oil 1 (sunflower oil) and the vulcanized rubber of the rubber composition of Example 6 containing vegetable oil 2 (palm oil) both have achieved improved reinforcement and significantly improved low heat build-up as compared to the vulcanized rubber of the rubber composition of Comparative Example 5 containing mineral oil (naphthenic oil).

TABLE 5

| | |
|---|---|
| Comparative | |
| Example 6 | Example 7 |

(Formulation)

| | | |
|---|---|---|
| NR | 40 | 40 |
| BR | | |
| SBR | 60 | 60 |
| CB1 | 40 | 40 |
| CB2 | | |
| CB3 | | |
| CB4 | | |
| CB5 | 20 | 20 |
| Silica | | |
| Silane coupling agent | | |
| Mineral oil (naphthenic oil) | 15 | |
| Vegetable oil 1 (sunflower oil) | | 15 |
| Vegetable oil 2 (palm olein) | | |
| Zinc oxide | 3 | 3 |
| Stearic acid | 2 | 2 |
| Wax | | |
| Antiaging agent 1 | | |
| Antiaging agent 2 | 0.5 | 0.5 |
| Hydrocarbon resin | 3 | 3 |
| Vulcanization accelerator 1 | 0.8 | 0.8 |
| Vulcanization accelerator 2 | | |
| Sulfur | 2.5 | 2.5 |

(Evaluations)

| | | |
|---|---|---|
| Viscosity (Processability) | 100 | 95 |
| Tensile product (reinforcement) | 100 | 112 |
| Low heat build-up (rolling | 100 | 97 |
| resistance) | | |

The blend systems shown in Table 5 are systems using CB1 whose N₂SA/IA is 0.94 m²/mg and CB5 that is recovered carbon black whose N₂SA/IA is 0.79 m²/mg in combination. As can be seen from the results shown in Table 5, the vulcanized rubber of the rubber composition of Example 7 containing vegetable oil 1 (sunflower oil) has achieved improved reinforcement and significantly improved low heat build-up as compared to the vulcanized rubber of the rubber composition of Comparative Example 6 containing mineral oil (naphthenic oil).

What is claimed is:

1. A rubber composition containing a diene-based rubber, carbon black, and vegetable oil,
wherein the carbon black has a ratio (N₂SA/IA) between nitrogen adsorption specific surface area (N₂SA) m²/g and iodine adsorption (IA) mg/g of 0.9 m²/mg or less, and
the vegetable oil is a glycerin fatty acid triester.

2. The rubber composition according to claim 1, wherein the carbon black is recovered carbon black.

3. The rubber composition according to claim 1, wherein the vegetable oil has an iodine value of 90 or less.

4. A pneumatic tire comprising at least a vulcanized rubber of the rubber composition according to claim 1.
